(19) United States
(12) Patent Application Publication
(10) Pub. No.: US 2026/0330899 A1
(43) Pub. Date: Oct. 22, 2026

(54) BICYCLE

(71) Applicant: Porsche eBike Performance D.O.O., Zagreb (HR)

(72) Inventors: Gabrijel SMOLJKIC, Samobor (HR); Jan Marius MEISTER, Zagreb (HR)

(73) Assignee: Porsche eBike Performance D.O.O., Zagreb (HR)

(21) Appl. No.: 19/099,604

(22) PCT Filed: Aug. 10, 2023
(86) PCT No.: PCT/EP2023/072164

§ 371 Date: Jan. 29, 2025

(30) Foreign Application Priority Data
Aug. 11, 2022 (EP) 22189930.5

(51) Int. Cl. G07C 5/08; B62J 45/20; B62J 45/41; H04N 23/57

(52) U.S. Cl. CPC G07C 5/0866; B62J 45/20; B62J 45/41; H04N 23/57; G06F 3/0631; G11B 2020/10666

(57) ABSTRACT

A bicycle has a bicycle frame (12), and front and rear wheels are mounted rotatably on the bicycle frame (12). The bicycle (12) also has a camera device (40) for recording the bicycle environment during a ride, a sensor device (42) for detecting riding data, and a recording memory device (46) for storing recordings recorded by the camera device (40) and the temporally associated travel data recorded by the sensor device (42). The camera device (40) records permanently during a ride and the recordings are stored in a permanent memory module (50) of the recording memory device (46). The recording memory device (46) is configured so that, based on a trigger signal, a recording sequence stored in time immediately prior to the trigger signal is stored with the associated ride data in a selection memory module (52).

### BACKGROUND

Field of the Invention. The invention relates to a bicycle that has a camera device for recording the bicycle environment during a ride, and a sensor device for recording ride data.

Related Art. The structure of a bicycle having a bicycle frame, a rear wheel, and a front wheel is generally known. The front wheel is supported rotatably at the bicycle frame via a front fork that is connected fixedly to a handlebar, and the rear wheel is supported rotatably at the bicycle frame via a rear wheel assembly. A bicycle with an electric drive unit to assist the rider in riding is known as a pedelec and is constructed as described above. Thus, a pedelec is understood to be a bicycle.

It is generally known that riding data can be recorded during the ride via bicycle computers, i.e. via a sensor device. In particular, the riding speed and the riding route are recorded and displayed to the rider. The riding data can also be stored for evaluation at a later time. A bicycle computer of this type is disclosed, for example, in DE 10 2004 044 545 A1.

It is also known that rides on a bicycle, in particular rides involving special maneuvers, such as riding a mountain bike off-road, are recorded via a camera device to record special events pictorially during the ride. The recordings are stored in a recording memory device. Such a bicycle with a camera device is disclosed, for example, in WO 2016/131104 A1.

The problem with these known devices is that the special and recording-relevant events occur sporadically during the ride, and the recording by the camera device usually is started only when the recording-relevant event, for example a particularly spectacular jump, has at least partially ended. It is also known that a future special event is detected by means of the riding data, and the camera device is activated automatically. In this case, the recording by the camera device takes place from the detection of the event, so that the riding operation lying in the future is recorded starting from the detection of the event. The disadvantage of this is that the beginning of the event, which is used to activate the camera device, is also not recorded and thus a decisive moment of the driving maneuver, which desirably should be recorded, is not recorded.

An object of the invention is to provide a bicycle with which special driving events occurring during riding with the bicycle are recorded reliably and completely.

### SUMMARY OF THE INVENTION

The invention relates to a bicycle comprising a bicycle frame. A rear wheel and a front wheel are supported rotatably on the bicycle frame. The bicycle also has a camera device for recording the bicycle environment during a ride, a sensor device for recording ride data, and a recording memory device for storing recordings recorded by the camera device and the ride data corresponding in time recorded by the sensor device.

In accordance with one aspect of the invention, the camera device permanently (i.e. continuously) records during a ride and the recording is stored in a permanent memory module of the recording memory device. The recording memory device is configured in such a way that a trigger signal causes a recording sequence that had been stored in the permanent memory module during a time immediately before the trigger signal then further is stored with the associated riding data in a selection memory module. Thus, in contrast to the procedure known in the prior art, in which an event lying in the future is recorded, a relevant driving event lying in the past and already recorded by the permanent recording is determined and made available to the driver as a recording sequence, i.e. stored in the selection memory module. The driver can have the recording sequence output and can share the outputted recording sequence with other people. This can be done, for example, through a USB or a wireless connection, such as a WLAN or Bluetooth connection. The recording sequence comprises both the pictorial recording by the camera device and the riding data associated by the sensor device.

The recording of the driving events lying in the past can, in addition to the special, fun-related driving events, also be used for the clarification of accidents with the bicycle. For example, abrupt changes in speed can be determined from the riding data and the stored recording sequence can be generated based on this.

Some embodiments have a trigger module in which predefined riding scenarios are stored. The trigger module may be configured so that a predefined riding scenario is detected based on the riding data during the ride, and a trigger signal is output. For example, a driving scenario can be detected based on the accelerations recorded by the sensor device. In particular, jumps or abrupt braking with the bicycle can be detected by evaluating the accelerations. The driving scenario associated with a jump with the bicycle over a jump is defined, for example, by an initial condition, in particular an acceleration against the acceleration due to gravity, and an end condition, in particular an acceleration in the direction of the acceleration due to gravity. Thus, the end condition can form the trigger signal and the recording sequence extends from the initial condition to the end condition. In this way, recordings can be made automatically and without manual interaction of the driver, which the driver can view and export after the journey.

Alternatively or additionally, a trigger element for generating a trigger signal may be arranged on the bicycle frame. The trigger element is, for example, a switch or button arranged on the handbar. After a particular riding event, the rider can actuate the trigger element and thus generate a trigger signal, so that a recording sequence is generated in time immediately before the trigger signal by the camera device in terms of images and recorded by the sensor device in accordance with the riding data. Thus, riding events that do not correspond to any particular riding scenario that can be recognized by the riding data can also be recorded.

The recording sequence can be defined as previously described by predefined riding data or simply by a predetermined time duration. The time duration may extend into the past starting from the trigger signal.

In some embodiments, the recording memory device comprises a ring memory in which temporally successive recording sections can be stored. The recording sequence can be composed of a plurality of recording sections. The ring memory may be configured in such a way that the recordings of the camera device and the associated riding data of the sensor device are continuously stored in a plurality of temporally successive recording sections. Thus, as soon as the ring memory is full, i.e. for example after twenty recording sections, the recording sections are overwritten by later recording sections of the camera device and the riding data of the sensor device. In this way, the memory space for the permanent recording of the camera device can be reduced. The recording sections comprise a predefined time duration. Preferably, the recording sequence is formed by one or more recording sections.

In some embodiments, the sensor device comprises a location sensor, a speed sensor and/or an acceleration sensor. In this way, for example, riding at particular locations, in particular by means of the location sensor, or particular riding events, in particular by means of the speed sensor and/or acceleration sensor, can be determined and recorded.

Thus, a bicycle is provided with which riding events occurring during a ride with the bicycle can be recorded reliably and completely in a simple manner.

An embodiment of the invention is explained in more detail with reference to the drawing.

### BRIEF DESCRIPTION OF THE DRAWINGS

FIG. 1 schematically shows a bicycle in side view.

### DETAILED DESCRIPTION

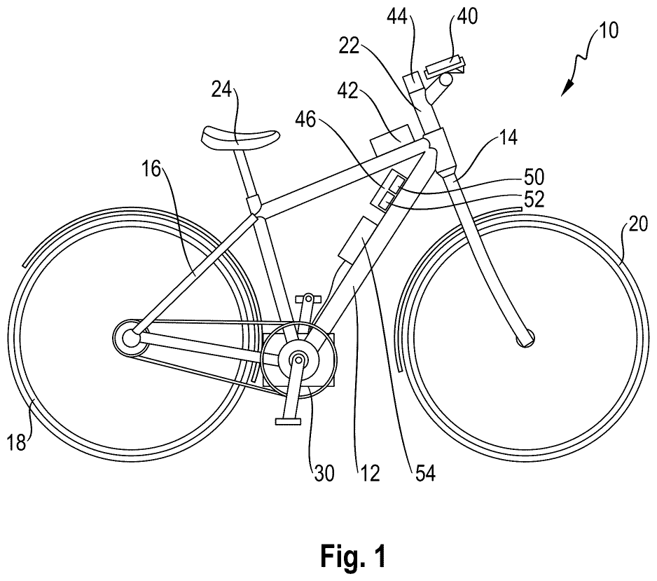

FIG. 1 shows a bicycle 10 configured as a pedelec, i.e., with pedal assist. The bicycle 10 comprises a bicycle frame 12 that comprises a structure with a down tube, a top tube, a seat post tube receiving a seat post 24 and a front fork receiving tube. Further, the bicycle frame 12 comprises a rear wheel receiving tube 16, and a rear wheel 18 is mounted rotatably to the rear wheel receiving assembly 16. A front fork 14 is mounted rotatably to the front fork receiving tube. The front fork is non-rotatably connected to a handlebar 22 and to which a front wheel 20 is mounted rotatably. Furthermore, the bicycle 10 has a drive device 30 with two pedals arranged on a pedal crank in each case. The pedal cranks are connected to a pedal crank shaft in a rotationally fixed manner. A chainring is non-rotatably arranged on the pedal crankshaft, and the chainring is connected to a chain sprocket of the rear wheel via a chain.

A camera device 40 is attached to the handlebar 22 to record visually the rides with the bicycle, in particular riding maneuvers, such as with a mountain bike in off-road terrain, wherein the camera device 40 records the environment in front of the bicycle 10. Alternatively or additionally, a camera device also may be arranged in the rear area of the bicycle 10, for example on the seat post tube, and this camera device is oriented such that the area behind the bicycle 10 is recorded. Furthermore, a sensor device 42 is attached to the bicycle frame 12 and comprises a location sensor, i.e. a GPS sensor, and an acceleration sensor. In addition, the sensor device 42 may further comprise a speed sensor or other sensor suitable for recording riding data.

The permanent recordings made by the camera device 40 and the riding data recorded by the sensor device 42 are stored in a recording memory device 46. The recording memory device 46 comprises a permanent memory module 50 configured as a ring memory. In the ring memory, the recordings of the camera device 40 and the associated riding data of the sensor device 42 are stored continuously in a plurality of recording sections following one another in time. As soon as the ring memory is full, i.e. after twenty recording sections, for example, the existing recording sections are overwritten by later recording sections of the camera device 40 and the riding data of the sensor device 42

Furthermore, the recording memory device 46 comprises a selection memory module 52 in which selected recordings are stored. The selected shots are generated in such a way that, based on a trigger signal, a recording section stored in time immediately before the trigger signal is stored in the selection memory module 52 together with the associated riding data. The recording sequence is composed of a plurality of recording sections stored in the ring buffer in time before the trigger signal.

On the one hand, the trigger signal is generated automatically by evaluating the riding data recorded by the sensor device 42 by means of a trigger module 54 arranged on the bicycle frame 12. Different riding scenarios are stored in the trigger module 54 and a riding scenario lying in the past is detected as a function of predefined riding data and the selected recording sequence is generated. On the other hand, a trigger signal can be triggered manually by the driver using a trigger element 44, in particular a switch or a button. The trigger element 44 is arranged on the handlebar 22 and can be easily operated by the driver.

The recording scenarios can be read out and exported by a readout device, in particular via a USB, a Bluetooth or a WLAN connection.

In this way, a bicycle 10 is provided with which special riding events occurring during the ride with the bicycle 10 can be recorded reliably and completely in terms of images and riding data.

1. A bicycle comprising:
a bicycle frame (12);
a rear wheel (18) and a front wheel (20) mounted rotatably on the bicycle frame (12);
a camera device (40) for recording the bicycle environment during a ride, the camera device recording continuously during the ride;
a sensor device (42) for recording riding data;
a recording memory device (46) with a permanent memory module (50) and a selection memory module (52), the permanent memory module (50) stores recordings recorded by the camera device (40) and the selection memory module (52) at least temporally storing the riding data recorded by the sensor device (42),
wherein the recording memory device (46) is configured in such a way that, based on a trigger signal, a recording sequence of the camera device (40) that was stored in the permanent memory module (50) during a time immediately prior to the trigger signal further is stored with the associated ride data in the selection memory module (52) of the recording memory device (46).

2. The bicycle of claim 1, further comprising a trigger module (54) that stores predefined riding scenarios, the trigger module (54) being configured so that, based on the riding data, a predefined riding scenario is detected during the ride and the trigger signal is output.

3. The bicycle of claim 1, further comprising a trigger element (44) arranged on the bicycle frame (12) and configured for generating the trigger signal.

4. The bicycle of claim 1, wherein the recording memory device (46) comprises a ring memory in which a plurality of temporally successive recording sections can be stored, wherein the recording sequence can be composed of one or more of the recording sections.

5. The bicycle of claim 1, wherein the sensor device (42) comprises a location sensor, a speed sensor and/or an acceleration sensor.
